(19) United States
(12) Patent Application Publication
(10) Pub. No.: US 2013/0235596 A1
(43) Pub. Date: Sep. 12, 2013

(54) CUP-SHAPED HEAT DISSIPATION MEMBER APPLICABLE IN ELECTRIC-POWERED LIGHT EMITTING UNIT

(71) Applicant: Tai-Her YANG, Dzan-Hwa (TW)

(72) Inventor: Tai-Her YANG, Dzan-Hwa (TW)

(21) Appl. No.: 13/417,393

(22) Filed: Mar. 12, 2012

(51) Int. Cl. F21V 29/00

(52) U.S. Cl. 362/382

(57) ABSTRACT

The present invention provides a novel cup-shaped heat dissipation member aimed to meet the heat dissipation requirement of an electric-powered light emitting unit; the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed on the inner recessed surface of the cup-shaped structure, thereby assisting the electric-powered light emitting unit (200) to dissipate heat to the exterior.

### BACKGROUND OF THE INVENTION

(a) Field of the Invention

The present invention provides a novel cup-shaped heat dissipation member aimed to meet the heat dissipation requirement of an electric-powered light emitting unit, e.g. the heat dissipation requirement of a light emitting diode (LED) which is adopted as the electric-powered light emitting unit (200); the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed on the inner recessed surface of the cup-shaped structure, thereby assisting the electric-powered light emitting unit (200) to dissipate heat to the exterior.

(b) Description of the Prior Art

A conventional heat dissipation device applicable in the electric-powered light emitting unit (200) of an electric illumination device, e.g. the heat dissipation member used in a LED illumination device, usually transmits the heat energy generated by the LED to the heat dissipation member then dissipate the heat energy to the exterior through the surface of the heat dissipation member, thereby limiting the heat dissipation area.

### SUMMARY OF THE INVENTION

A conventional heat dissipation device applied in the electric-powered light emitting unit (200) of an electric illumination device, e.g. the heat dissipation member used in a LED illumination device, usually transmits the heat energy generated by the LED to the heat dissipation member then dissipate the heat energy to the exterior through the surface of the heat dissipation member, thereby limiting the heat dissipation area; the present invention provides a novel cup-shaped heat dissipation member aimed to meet the heat dissipation requirement of an electric-powered light emitting unit, e.g. the heat dissipation requirement of a light emitting diode (LED) which is adopted as the electric-powered light emitting unit (200); the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed on the inner recessed surface of the cup-shaped structure, thereby assisting the electric-powered light emitting unit (200) to dissipate heat to the exterior.

### BRIEF DESCRIPTION OF THE DRAWINGS

FIG. 1 is a cross sectional view showing the basic structure of the heat dissipation member (100), according to the present invention.

FIG. 2 is a schematic top view of FIG. 1 taken alone A-A cross section.

FIG. 3 is a cross section view illustrating the cup-shaped structure formed in the heat dissipation member (100) opposite to the installation location of the electric-powered light emitting unit (200) being formed with a single annular groove structure, according to the present invention.

FIG. 4 is a schematic top view of FIG. 3.

FIG. 5 is a cross section view illustrating the cup-shaped structure formed in the heat dissipation member (100) opposite to the installation location of the electric-powered light emitting unit (200) being formed with a multiple annular groove structure, according to the present invention.

FIG. 6 is a schematic top view of FIG. 5.

FIG. 7 is a cross section view illustrating the cup-shaped structure formed in the heat dissipation member (100) opposite to the installation location of the electric-powered light emitting unit (200) being formed with a single annular groove and a stepped structure having a higher central column and a lower outer periphery, according to the present invention.

FIG. 8 is a schematic top view of FIG. 7.

FIG. 9 is another cross section view illustrating the cup-shaped structure formed in the heat dissipation member (100) opposite to the installation location of the electric-powered light emitting unit (200) being formed with a single annular groove and a stepped structure having a lower central column and a higher outer periphery, according to the present invention.

FIG. 10 is a schematic top view of FIG. 9.

FIG. 11 is one another cross section view illustrating the cup-shaped structure formed in the heat dissipation member (100) opposite to the installation location of the electric-powered light emitting unit (200) being formed with multiple annular grooves (104) and a stepped structure having a higher central column (103) and a lower outer periphery, according to the present invention.

FIG. 12 is a schematic top view of FIG. 11.

FIG. 13 is a schematic lateral view illustrating the upper periphery of the cup-shaped structure formed in the heat dissipation member (100) opposite to the installation location of the electric-powered light emitting unit (200) being formed with a crown-like tooth notch (105) and a structure having a central column (103) and an outer periphery being at the same height, according to the present invention.

FIG. 14 is a schematic top view of FIG. 13.

FIG. 15 is another schematic lateral view illustrating the upper periphery of the cup-shaped structure formed in the heat dissipation member (100) opposite to the installation location of the electric-powered light emitting unit (200) being formed with multiple crown-like tooth notches (105) and a structure having a higher central column (103) and a lower outer periphery, according to the present invention.

FIG. 16 is a schematic top view of FIG. 15.

FIG. 17 is a partial cross sectional view illustrating the heat dissipation member (100) opposite to the installation location of the electric-powered light emitting unit (200) being installed with a conical column member and the cup-shaped structure being formed as a fork-shaped annular structure, according to the present invention.

FIG. 18 is a schematic top view of FIG. 17.

FIG. 19 is a schematic lateral view illustrating the interior of the cup-shaped structure formed in the heat dissipation member (100) opposite to the installation location of the electric-powered light emitting unit (200) being installed with a multiple-plate type heat dissipation structure (107), according to the present invention.

FIG. 20 is a schematic top view of FIG. 19.

FIG. 21 is a schematic lateral view illustrating the interior of the cup-shaped structure formed in the heat dissipation member (100) opposite to the installation location of the electric-powered light emitting unit (200) being installed with a multiple-column type heat dissipation structure (108), according to one embodiment of the present invention.

FIG. 22 is a schematic top view of FIG. 21.

FIG. 23 is a schematic lateral view illustrating the top of the heat dissipation member (100) opposite to the installation location of the electric-powered light emitting unit (200) being additionally installed with a protection net (109), according to one embodiment of the present invention.

FIG. 24 is a schematic lateral view illustrating the top of the heat dissipation member (100) opposite to the installation location of the electric-powered light emitting unit (200) being installed with a top cover (110), and formed with a ventilation hole (112) and a support column (111) served for combining and supporting between the top cover (110) and the heat dissipation member (100), according to one embodiment of the present invention.

FIG. 25 is a schematic lateral view illustrating the support column (111) served for combining and supporting being installed between the top of the heat dissipation member (100) opposite to the installation location of the electric-powered light emitting unit (200) and the top cover (110), and the periphery of the ventilation hole (112) being additionally installed with the protection net (109), according to one embodiment of the present invention.

### DESCRIPTION OF MAIN COMPONENT SYMBOLS

(100): Heat dissipation member
(101): Annular surface of heat dissipation member
(102): Cup-shaped space
(103): Central column
(104): Annular groove
(105): Tooth notch
(106): Fork-shaped annular structure
(107): Multiple-plate type heat dissipation structure
(108): Multiple-column type heat dissipation structure
(109): Protection net
(110): Top cover
(111): Support column
(112): Ventilation port
(200): Electric-powered light emitting unit

### DETAILED DESCRIPTION OF THE PREFERRED EMBODIMENTS

A conventional heat dissipation device applicable in the electric-powered light emitting unit (200) of an electric illumination device, e.g. the heat dissipation member used in a LED illumination device, usually transmits the heat energy generated by the LED to the heat dissipation member then dissipate the heat energy to the exterior through the surface of the heat dissipation member, thereby limiting the heat dissipation area;

The present invention provides a novel cup-shaped heat dissipation member aimed to meet the heat dissipation requirement of an electric-powered light emitting unit, e.g. the heat dissipation requirement of a light emitting diode (LED) which is adopted as the electric-powered light emitting unit (200); the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed on the inner recessed surface of the cup-shaped structure, thereby assisting the electric-powered light emitting unit (200) to dissipate heat to the exterior.

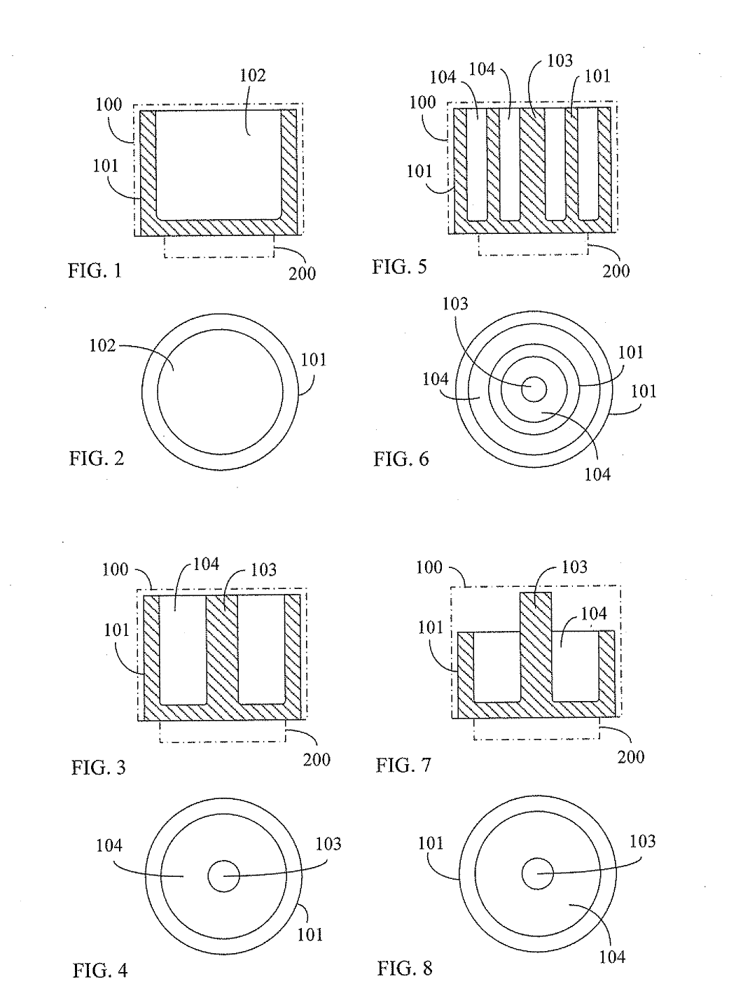

FIG. 1 is a cross sectional view showing the basic structure of the heat dissipation member (100), according to the present invention;

FIG. 2 is a schematic top view of FIG. 1 taken alone A-A cross section;

As shown in FIG. 1 and FIG. 2, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours;

the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed at the inner recessed surface of the cup-shaped structure, thereby assisting the electric-powered light emitting unit (200) to dissipate heat to the exterior.

FIG. 3 is a cross section view illustrating the cup-shaped structure formed in the heat dissipation member (100) opposite to the installation location of the electric-powered light emitting unit (200) being formed with a single annular groove structure, according to the present invention;

FIG. 4 is a schematic top view of FIG. 3;

As shown in FIG. 3 and FIG. 4, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a central column (103);

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure having the single annular groove (104) and the central column (103) opposite to the installation location of the electric-powered light emitting unit (200), the heat energy inside the heat dissipation member (100) can also be directly dissipated to the exterior through a larger heat dissipation area defined by the single annular groove (104) and the central column (103) at the inner recessed surface of the cup-shaped structure and the annular surface of heat dissipation member (101) of the heat dissipation member (100), thereby assisting the electric-powered light emitting unit (200) to dissipate heat to the exterior.

FIG. 5 is a cross section view illustrating the cup-shaped structure formed in the heat dissipation member (100) opposite to the installation location of the electric-powered light emitting unit (200) being formed with a multiple annular groove structure, according to the present invention;

FIG. 6 is a schematic top view of FIG. 5;

As shown in FIG. 5 and FIG. 6, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has two or more than two annular grooves (104) and a central column (103) and two or more than two layers of annular surfaces of heat dissipation member (101);

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being fromed with the two or more than two annular grooves (104) and the central column (103) and the two or more than two layers of the annular surfaces of heat dissipation member (101), the heat energy inside the heat dissipation member (100) can also be directly dissipated to the exterior through a larger heat dissipation area defined by the two or more than two annular grooves (104) and the central column (103) at the inner recessed surface of the cup-shaped structure and the two or more than two layers of the annular surfaces of heat dissipation member (101) of the heat dissipation member (100), thereby assisting the electric-powered light emitting unit (200) to dissipate heat to the exterior.

FIG. 7 is a cross section view illustrating the cup-shaped structure formed in the heat dissipation member (100) opposite to the installation location of the electric-powered light emitting unit (200) being formed with a single annular groove and a stepped structure having a higher central column and a lower outer periphery, according to the present invention;

FIG. 8 is a schematic top view of FIG. 7;

As shown in FIG. 7 and FIG. 8, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a higher central column (103), thereby forming a stepped structure having the higher central column and the lower outer periphery;

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the single annular groove (104) and the higher central column (103), thereby forming a structure having the higher central column and the lower outer periphery, the heat energy inside the heat dissipation member (100) can also be directly dissipated to the exterior through a larger heat dissipation area defined by the single annular groove (104) and the higher central column (103) forming the structure having the higher central column and the lower outer periphery at the inner recessed surface of the cup-shaped structure and the annular surface of heat dissipation member (101) of the heat dissipation member (100), thereby assisting the electric-powered light emitting unit (200) to dissipate heat to the exterior.

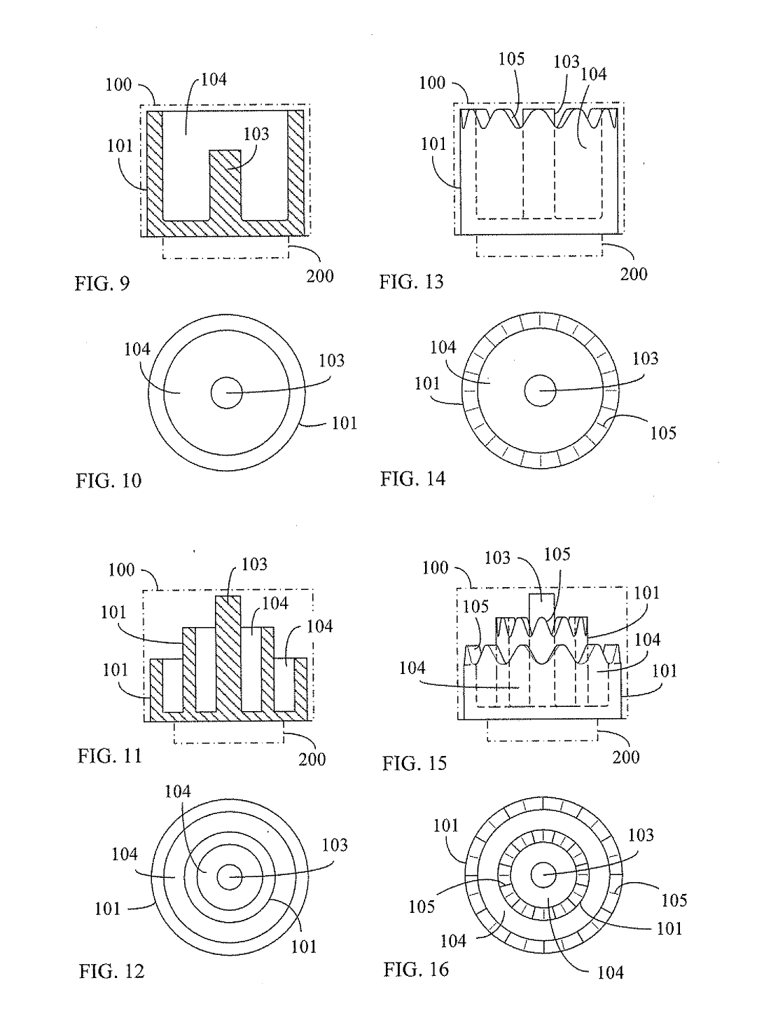

FIG. 9 is another cross section view illustrating the cup-shaped structure formed in the heat dissipation member (100) opposite to the installation location of the electric-powered light emitting unit (200) being formed with a single annular groove and a stepped structure having a lower central column and a higher outer periphery, according to the present invention;

FIG. 10 is a schematic top view of FIG. 9;

As shown in FIG. 9 and FIG. 10, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a lower central column (103), thereby forming a stepped structure having the lower central column and the higher outer periphery;

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the single annular groove (104) and the lower central column (103), thereby forming a structure having the lower central column and the higher outer periphery, the heat energy inside the heat dissipation member (100) can also be directly dissipated to the exterior through a larger heat dissipation area defined by the single annular groove (104) and the lower central column (103) forming the structure having the lower central column and the higher outer periphery at the inner recessed surface of the cup-shaped structure and the annular surface of heat dissipation member (101) of the heat dissipation member (100), thereby assisting the electric-powered light emitting unit (200) to dissipate heat to the exterior.

FIG. 11 is one another cross section view illustrating the cup-shaped structure formed in the heat dissipation member (100) opposite to the installation location of the electric-powered light emitting unit (200) being formed with multiple annular grooves (104) and a stepped structure having a higher central column (103) and a lower outer periphery, according to the present invention;

FIG. 12 is a schematic top view of FIG. 11;

As shown in FIG. 11 and FIG. 12, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has two or more than two annular grooves (104) and a central column (103) and two or more than two layers of annular surfaces of heat dissipation member (101), thereby forming a multiple stepped structure having the lower outer periphery.

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with two or more than two annular grooves (104) and a central column (103) and two or more than two layers of annular surfaces of heat dissipation member (101), thereby forming a multiple stepped structure having the lower outer periphery, the heat energy inside the heat dissipation member (100) can also be directly dissipated to the exterior through a larger heat dissipation area defined by the two or more than two annular grooves (104) and the central column (103) at the inner recessed surface of the cup-shaped structure and the two or more than two layers of the annular surfaces of heat dissipation member (101) forming the multiple stepped structure having the lower outer periphery and the annular surface of heat dissipation member (101) of the heat dissipation member (100), thereby assisting the electric-powered light emitting unit (200) to dissipate heat to the exterior.

The mentioned heat dissipation member (100) further includes that the cup-shaped structure formed in the heat dissipation member (100) opposite to the installation location of the electric-powered light emitting unit (200) has two or more than two annular grooves (104) and a central columns (103) and two or more than two layers of annular surfaces of heat dissipation member (101), thereby forming a multiple-stepped structure having the higher outer periphery.

FIG. 13 is a schematic lateral view illustrating a structure that the upper periphery of the cup-shaped structure formed in the heat dissipation member (100) opposite to the installation location of the electric-powered light emitting unit (200) being formed with a crown-like tooth notch (105) and a central column (103) and an outer periphery being at the same height, according to the present invention;

FIG. 14 is a schematic top view of FIG. 13;

As shown in FIG. 13 and FIG. 14, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the upper periphery of the cup-shaped structure formed in the heat dissipation member (100) opposite to the installation location of the electric-powered light emitting unit (200) is formed with the annular structure having the crown-like tooth notch (105) and the central column (103), thereby forming a structure having the central column (103) and the annular structure having the crown-like tooth notch (105) at the outer periphery at the same height;

the outer bottom side of the cup-shaped heat dissipation member is installed with the electric-powered light emitting unit (200), so the heat energy from the electric-powered light emitting unit (200) cannot only be dissipated to the exterior from a surface of annular heat dissipation member (101), with the upper periphery of the heat dissipation member (100) opposite to the installation location of the electric-powered light emitting unit (200) being installed with the annular structure having the crown-like tooth notch (105) and the central column (103), and the central column (103) has the same height as the outer periphery, the heat energy inside the heat dissipation member (100) can also be directly dissipated to the exterior through a larger heat dissipation area defined by the annular groove (104) on the inner recessed surface of the cup-shaped structure and the annular structure having the crown-like tooth notch (105), the structure in which the central column (103) having the same height as the outer periphery of the annular structure having the crown-like tooth notch (105), and the annular surface of heat dissipation member (101) of the heat dissipation member (100), thereby assisting the electric-powered light emitting unit (200) to dissipate heat to the exterior;

The multiple annular structure of the mentioned multiple crown-like tooth notches (105) is defined as two or more than two layers.

FIG. 15 is another schematic lateral view illustrating a structure that the upper periphery of the cup-shaped structure formed in the heat dissipation member (100) opposite to the installation location of the electric-powered light emitting unit (200) being formed with multiple crown-like tooth notches (105) and a higher central column (103) and a lower outer periphery, according to the present invention;

FIG. 16 is a schematic top view of FIG. 15;

As shown in FIG. 15 and FIG. 16, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the upper periphery of the cup-shaped structure formed in the heat dissipation member (100) opposite to the installation location of the electric-powered light emitting unit (200) is formed with the multiple crown-like tooth notches (105) and the central column (103), thereby forming a structure having the higher central column (103) and the lower multiple annular structure having the crown-like tooth notches (105) at the outer periphery;

the outer bottom side of the cup-shaped heat dissipation member is installed with the electric-powered light emitting unit (200), so the heat energy from the electric-powered light emitting unit (200) cannot only be dissipated to the exterior from an surface of annular heat dissipation member (101), with the upper periphery of the heat dissipation member (100) opposite to the installation location of the electric-powered light emitting unit (200) being installed with the multiple annular structure having the crown-like tooth notch (105) and the central column (103), thereby forming a structure having the higher central column (103) and the lower multiple annular structure having the crown-like tooth notches (105) at the outer periphery, the heat energy inside the heat dissipation member (100) can also be directly dissipated to the exterior through a larger heat dissipation area defined by the multiple annular grooves (104) on the inner recessed surface of the cup-shaped structure and the multiple annular structure having the multiple crown-like tooth notches (105), and the central column (103) and the annular surface of heat dissipation member (101) of the heat dissipation member (100), thereby assisting the electric-powered light emitting unit (200) to dissipate heat to the exterior.

The mentioned heat dissipation member (100) further includes that the upper periphery of the cup-shaped structure formed in the heat dissipation member (100) opposite to the installation location of the electric-powered light emitting unit (200) has multiple crown-like tooth notches (105) and the central column (103), thereby forming a structure having the lower central column (103) and the higher multiple annular structure having the crown-like tooth notches (105) at the outer periphery;

The multiple annular structure of the mentioned multiple crown-like tooth notches (105) is defined as two or more than two layers.

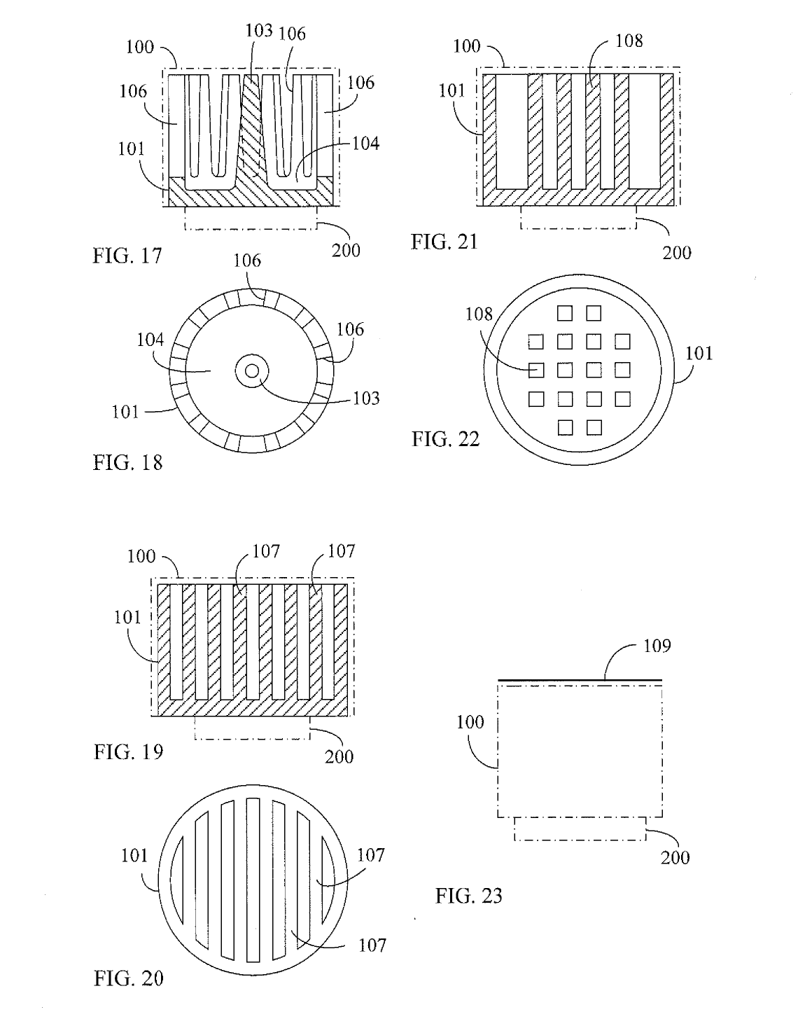

FIG. 17 is a partial cross sectional view illustrating the heat dissipation member (100) opposite to the installation location of the electric-powered light emitting unit (200) being installed with a conical column member and the cup-shaped structure being formed as a fork-shaped annular structure, according to the present invention;

FIG. 18 is a schematic top view of FIG. 17;

As shown in FIG. 17 and FIG. 18, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a fork-shaped annular structure (106) and a conical column (103);

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the fork-shaped annular structure (106) and installed with the conical central column (103), the heat energy inside the heat dissipation member (100) can also be directly dissipated to the exterior through a larger heat dissipation area defined by the fork-shaped annular structure at the inner recessed surface of the cup-shaped structure and the annular surface of heat dissipation member (101) of the heat dissipation member (100) and the conical central column (103), thereby assisting the electric-powered light emitting unit (200) to dissipate heat to the exterior.

FIG. 19 is a schematic lateral view illustrating the interior of the cup-shaped structure formed in the heat dissipation member (100) opposite to the installation location of the electric-powered light emitting unit (200) being installed with a multiple-plate type heat dissipation structure (107), according to the present invention;

FIG. 20 is a schematic top view of FIG. 19;

As shown in FIG. 19 and FIG. 20, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the interior of the cup-shaped structure formed in the heat dissipation member (100) opposite to the installation location of the electric-powered light emitting unit (200) being installed with a multiple-plate type heat dissipation structure (107);

the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the interior of the cup-shaped structure opposite to the installation location of the electric-powered light emitting unit (200) being formed with the multiple-plate type heat dissipation structure (107), the heat energy inside the heat dissipation member (100) can also be directly dissipated to the exterior through a larger heat dissipation area defined by the multiple-plate type heat dissipation structure (107) at the inner recessed surface of the cup-shaped structure and the annular surface of heat dissipation member (101) of the heat dissipation member (100), thereby assisting the electric-powered light emitting unit (200) to dissipate heat to the exterior.

FIG. 21 is a schematic lateral view illustrating the interior of the cup-shaped structure formed in the heat dissipation member (100) opposite to the installation location of the electric-powered light emitting unit (200) being installed with a multiple-column type heat dissipation structure (108), according to one embodiment of the present invention;

FIG. 22 is a schematic top view of FIG. 21;

As shown in FIG. 21 and FIG. 22, it mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the interior of the cup-shaped structure formed in the heat dissipation member (100) opposite to the installation location of the electric-powered light emitting unit (200) being installed with a multiple-column type heat dissipation structure (108);

the outer bottom side of the cup-shaped heat dissipation member is installed with the electric-powered light emitting unit (200), so the heat energy from the electric-powered light emitting unit (200) cannot only be dissipated to the exterior from a annular surface of heat dissipation member (101), with the interior of the cup-shaped structure opposite to the installation location of the electric-powered light emitting unit (200) being formed with the multiple-column type heat dissipation structure (108), the heat energy inside the heat dissipation member (100) can also be directly dissipated to the exterior through a larger heat dissipation area defined by the multiple-column type heat dissipation structure (108) at the inner recessed surface of the cup-shaped structure and the annular surface of heat dissipation member (101) of the heat dissipation member (100), thereby assisting the electric-powered light emitting unit (200) to dissipate heat to the exterior.

FIG. 23 is a schematic lateral view illustrating the top of the heat dissipation member (100) opposite to the installation location of the electric-powered light emitting unit (200) being additionally installed with a protection net (109), according to one embodiment of the present invention;

As shown in FIG. 23, according to one embodiment of the present invention, the top of the heat dissipation member (100) opposite to the installation location of the electric-powered light emitting unit (200) is additionally installed with the protection net (109).

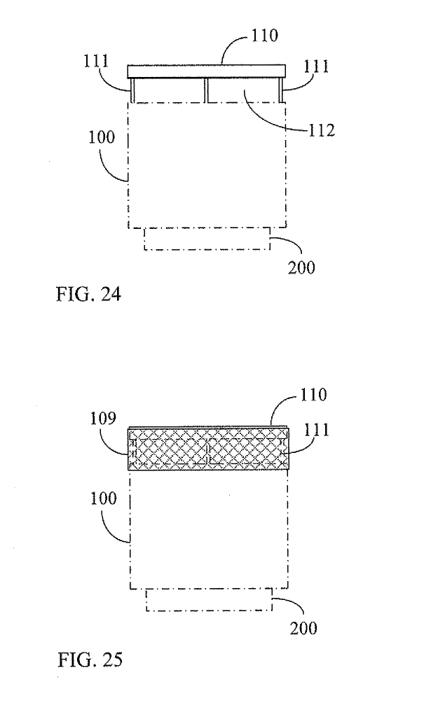

FIG. 24 is a schematic lateral view illustrating the top of the heat dissipation member (100) opposite to the installation location of the electric-powered light emitting unit (200) being installed with a top cover (110), and formed with a ventilation port (112) and a support column (111) served for combining and supporting between the top cover (110) and the heat dissipation member (100), according to one embodiment of the present invention;

As shown in FIG. 24, according to one embodiment of the present invention, the top of the heat dissipation member (100) opposite to the installation location of the electric-powered light emitting unit (200) being installed with a top cover (110), and formed with a ventilation port (112) and a support column (111) served for combining and supporting between the top cover (110) and the heat dissipation member (100).

FIG. 25 is a schematic lateral view illustrating the support column (111) served for combining and supporting being installed between the top of the heat dissipation member (100) opposite to the installation location of the electric-powered light emitting unit (200) and the top cover (110), and the periphery of the ventilation port (112) being additionally installed with the protection net (109), according to one embodiment of the present invention;

As shown in FIG. 25, according to one embodiment of the present invention, the support column (111) served for combining and supporting being installed between the top of the heat dissipation member (100) opposite to the installation location of the electric-powered light emitting unit (200) and the top cover (110), and the periphery of the ventilation port (112) being additionally installed with the protection net (109).

The mentioned electric-powered light emitting unit (200) according to the cup-shaped heat dissipation member applicable in an electric-powered light emitting unit of the present invention, the structural configuration thereof can further include being composed of the electric-powered light emitting unit and optical component and lampshade.

1. A Cup-shaped heat dissipation member applicable in electric-powered light emitting unit, which provides a cup-shaped heat dissipation member and the outer bottom side of the cup-shaped heat dissipation member thereof is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed on the inner recessed surface of the cup-shaped structure, thereby assisting the electric-powered light emitting unit (200) to dissipate heat to the exterior, which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours;
the outer bottom side of the cup-shaped heat dissipation member is installed with the electric-powered light emitting unit (200), so the heat energy from the electric-powered light emitting unit (200) cannot only be dissipated to the exterior from the surface of the heat dissipation member, with the enlarged inner recessed surface formed on the cup-shaped structure in the heat dissipation member (100) opposite to the installation location of the electric-powered light emitting unit (200), the heat energy inside the heat dissipation member (100) can also be directly dissipated through the larger heat dissipation area formed at the inner recessed surface of the cup-shaped structure, thereby assisting the electric-powered light emitting unit (200) to dissipate heat to the exterior.

2. A Cup-shaped heat dissipation member applicable in electric-powered light emitting unit as claimed in claim 1, wherein the cup-shaped structure formed in the heat dissipation member (100) opposite to the installation location of the electric-powered light emitting unit (200) is formed with a single annular groove structure, which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a central column (103);
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure having the single annular groove (104) and the central column (103) opposite to the installation location of the electric-powered light emitting unit (200), the heat energy inside the heat dissipation member (100) can also be directly dissipated to the exterior through a larger heat dissipation area defined by the single annular groove (104) and the central column (103) at the inner recessed surface of the cup-shaped structure and the annular surface of heat dissipation member (101) of the heat dissipation member (100), thereby assisting the electric-powered light emitting unit (200) to dissipate heat to the exterior.

3. A Cup-shaped heat dissipation member applicable in electric-powered light emitting unit as claimed in claim 2, wherein the cup-shaped structure formed in the heat dissipation member (100) opposite to the installation location of the electric-powered light emitting unit (200) is formed with a multiple annular groove structure, which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has two or more than two annular grooves (104) and a central column (103) and two or more than two layers of annular surfaces of heat dissipation member (101);
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the two or more than two annular grooves (104) and the central column (103) and the two or more than two layers of the annular surfaces of heat dissipation member (101), the heat energy inside the heat dissipation member (100) can also be directly dissipated to the exterior through a larger heat dissipation area defined by the two or more than two annular grooves (104) and the central column (103) at the inner recessed surface of the cup-shaped structure and the two or more than two layers of the annular surfaces of heat dissipation member (101) of the heat dissipation member (100), thereby assisting the electric-powered light emitting unit (200) to dissipate heat to the exterior.

4. A Cup-shaped heat dissipation member applicable in electric-powered light emitting unit as claimed in claim 2, wherein the cup-shaped structure opposite to the installation location of the electric-powered light emitting unit (200) formed with a single annular groove and a stepped structure having a higher central column and a lower outer periphery are installed to the heat dissipation member (100), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a higher central column (103), thereby forming a stepped structure having the higher central column and the lower outer periphery;
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the single annular groove (104) and the higher central column (103), thereby forming a structure having the higher central column and the lower outer periphery, the heat energy inside the heat dissipation member (100) can also be directly dissipated to the exterior through a larger heat dissipation area defined by the single annular groove (104) and the higher central column (103) forming the structure having the higher central column and the lower outer periphery at the inner recessed surface of the cup-shaped structure and the annular surface of heat dissipation member (101) of the heat dissipation member (100), thereby assisting the electric-powered light emitting unit (200) to dissipate heat to the exterior.

5. A Cup-shaped heat dissipation member applicable in electric-powered light emitting unit as claimed in claim 2, wherein the cup-shaped structure opposite to the installation location of the electric-powered light emitting unit (200) formed with a single annular groove and a stepped structure having a lower central column and a higher outer periphery are installed to the heat dissipation member (100), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a single annular groove (104) and a lower central column (103), thereby forming a stepped structure having the lower central column and the higher outer periphery;
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the single annular groove (104) and the lower central column (103), thereby forming a structure having the lower central column and the higher outer periphery, the heat energy inside the heat dissipation member (100) can also be directly dissipated to the exterior through a larger heat dissipation area defined by the single annular groove (104) and the lower central column (103) forming the structure having the lower central column and the higher outer periphery at the inner recessed surface of the cup-shaped structure and the annular surface of heat dissipation member (101) of the heat dissipation member (100), thereby assisting the electric-powered light emitting unit (200) to dissipate heat to the exterior.

6. A Cup-shaped heat dissipation member applicable in electric-powered light emitting unit as claimed in claim 2, wherein the cup-shaped structure opposite to the installation location of the electric-powered light emitting unit (200) formed with multiple annular grooves (104) and a stepped structure having a higher central column (103) and a lower outer periphery are installed to the heat dissipation member (100), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has two or more than two annular grooves (104) and a central column (103) and two or more than two layers of annular surfaces of heat dissipation member (101), thereby forming a multiple stepped structure having the lower outer periphery;
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with two or more than two annular grooves (104) and a central column (103) and two or more than two layers of annular surfaces of heat dissipation member (101), thereby forming a multiple stepped structure having the lower outer periphery, the heat energy inside the heat dissipation member (100) can also be directly dissipated to the exterior through a larger heat dissipation area defined by the two or more than two annular grooves (104) and the central column (103) at the inner recessed surface of the cup-shaped structure and the two or more than two layers of the annular surfaces of heat dissipation member (101) forming the multiple stepped structure having the lower outer periphery and the annular surface of heat dissipation member (101) of the heat dissipation member (100), thereby assisting the electric-powered light emitting unit (200) to dissipate heat to the exterior;
The mentioned heat dissipation member (100) further includes that the cup-shaped structure formed in the heat dissipation member (100) opposite to the installation location of the electric-powered light emitting unit (200) has two or more than two annular grooves (104) and a central columns (103) and two or more than two layers of annular surfaces of heat dissipation member (101), thereby forming a multiple-stepped structure having the higher outer periphery.

7. A Cup-shaped heat dissipation member applicable in electric-powered light emitting unit as claimed in claim 1, wherein the upper periphery of the cup-shaped structure formed in the heat dissipation member (100) opposite to the installation location of the electric-powered light emitting unit (200) is formed with a crown-like tooth notch (105) and a central column (103) and an outer periphery are at the same height, which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the upper periphery of the cup-shaped structure formed in the heat dissipation member (100) opposite to the installation location of the electric-powered light emitting unit (200) is formed with the annular structure having the crown-like tooth notch (105) and the central column (103), thereby forming a structure having the central column (103) and the annular structure having the crown-like tooth notch (105) at the outer periphery at the same height;
the outer bottom side of the cup-shaped heat dissipation member is installed with the electric-powered light emitting unit (200), so the heat energy from the electric-powered light emitting unit (200) cannot only be dissipated to the exterior from a surface of annular heat dissipation member (101), with the upper periphery of the heat dissipation member (100) opposite to the installation location of the electric-powered light emitting unit (200) being installed with the annular structure having the crown-like tooth notch (105) and the central column (103), and the central column (103) has the same height as the outer periphery, the heat energy inside the heat dissipation member (100) can also be directly dissipated to the exterior through a larger heat dissipation area defined by the annular groove (104) on the inner recessed surface of the cup-shaped structure and the annular structure having the crown-like tooth notch (105), the structure in which the central column (103) having the same height as the outer periphery of the annular structure having the crown-like tooth notch (105), and the annular surface of heat dissipation member (101) of the heat dissipation member (100), thereby assisting the electric-powered light emitting unit (200) to dissipate heat to the exterior;
The multiple annular structure of the mentioned multiple crown-like tooth notches (105) is defined as two or more than two layers.

8. A Cup-shaped heat dissipation member applicable in electric-powered light emitting unit as claimed in claim 1, wherein the upper periphery of the cup-shaped structure opposite to the installation location of the electric-powered light emitting unit (200) is formed with multiple crown-like tooth notches (105) and a structure having a higher central column (103) and a lower outer periphery are installed to the heat dissipation member (100), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the upper periphery of the cup-shaped structure formed in the heat dissipation member (100) opposite to the installation location of the electric-powered light emitting unit (200) is formed with the multiple crown-like tooth notches (105) and the central column (103), thereby forming a structure having the higher central column (103) and the lower multiple annular structure having the crown-like tooth notches (105) at the outer periphery;
the outer bottom side of the cup-shaped heat dissipation member is installed with the electric-powered light emitting unit (200), so the heat energy from the electric-powered light emitting unit (200) cannot only be dissipated to the exterior from an surface of annular heat dissipation member (101), with the upper periphery of the heat dissipation member (100) opposite to the installation location of the electric-powered light emitting unit (200) being installed with the multiple annular structure having the crown-like tooth notch (105) and the central column (103), thereby forming a structure having the higher central column (103) and the lower multiple annular structure having the crown-like tooth notches (105) at the outer periphery, the heat energy inside the heat dissipation member (100) can also be directly dissipated to the exterior through a larger heat dissipation area defined by the multiple annular grooves (104) on the inner recessed surface of the cup-shaped structure and the multiple annular structure having the multiple crown-like tooth notches (105), and the central column (103) and the annular surface of heat dissipation member (101) of the heat dissipation member (100), thereby assisting the electric-powered light emitting unit (200) to dissipate heat to the exterior;
The mentioned heat dissipation member (100) further includes that the upper periphery of the cup-shaped structure formed in the heat dissipation member (100) opposite to the installation location of the electric-powered light emitting unit (200) has multiple crown-like tooth notches (105) and the central column (103), thereby forming a structure having the lower central column (103) and the higher multiple annular structure having the crown-like tooth notches (105) at the outer periphery;
The multiple annular structure of the mentioned multiple crown-like tooth notches (105) is defined as two or more than two layers.

9. A Cup-shaped heat dissipation member applicable in electric-powered light emitting unit as claimed in claim 2, wherein the heat dissipation member (100) opposite to the installation location of the electric-powered light emitting unit (200) is installed with a conical column member and the cup-shaped structure thereof is formed as a fork-shaped annular structure, which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the cup-shaped structure formed in the heat dissipation member (100) opposite to the installation location of the electric-powered light emitting unit (200) has a fork-shaped annular structure (106) and a conical column (103);
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the cup-shaped structure opposite to the installation location of the electric-powered light emitting unit (200) being formed with the fork-shaped annular structure (106) and installed with the conical central column (103), the heat energy inside the heat dissipation member (100) can also be directly dissipated to the exterior through a larger heat dissipation area defined by the fork-shaped annular structure at the inner recessed surface of the cup-shaped structure and the annular surface of heat dissipation member (101) of the heat dissipation member (100) and the conical central column (103), thereby assisting the electric-powered light emitting unit (200) to dissipate heat to the exterior.

10. A Cup-shaped heat dissipation member applicable in electric-powered light emitting unit as claimed in claim 2, wherein the interior of the cup-shaped structure formed in the heat dissipation member (100) opposite to the installation location of the electric-powered light emitting unit (200) is installed with a multiple-plate type heat dissipation structure (107), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the interior of the cup-shaped structure formed in the heat dissipation member (100) opposite to the installation location of the electric-powered light emitting unit (200) being installed with a multiple-plate type heat dissipation structure (107);
the outer bottom side of the cup-shaped heat dissipation member is installed with the electric-powered light emitting unit (200), so the heat energy from the electric-powered light emitting unit (200) cannot only be dissipated to the exterior from an annular surface of heat dissipation member (101), with the interior of the cup-shaped structure opposite to the installation location of the electric-powered light emitting unit (200) being formed with the multiple-plate type heat dissipation structure (107), the heat energy inside the heat dissipation member (100) can also be directly dissipated to the exterior through a larger heat dissipation area defined by the multiple-plate type heat dissipation structure (107) at the inner recessed surface of the cup-shaped structure and the annular surface of heat dissipation member (101) of the heat dissipation member (100), thereby assisting the electric-powered light emitting unit (200) to dissipate heat to the exterior.

11. A Cup-shaped heat dissipation member applicable in electric-powered light emitting unit as claimed in claim 2, wherein the interior of the cup-shaped structure formed in the heat dissipation member (100) opposite to the installation location of the electric-powered light emitting unit (200) is installed with a multiple-column type heat dissipation structure (108), which mainly consists of:
heat dissipation member (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein: the interior of the cup-shaped structure formed in the heat dissipation member (100) opposite to the installation location of the electric-powered light emitting unit (200) being installed with a multiple-column type heat dissipation structure (108);
the outer bottom side of the cup-shaped heat dissipation member is installed with the electric-powered light emitting unit (200), so the heat energy from the electric-powered light emitting unit (200) cannot only be dissipated to the exterior from a annular surface of heat dissipation member (101), with the interior of the cup-shaped structure opposite to the installation location of the electric-powered light emitting unit (200) being formed with the multiple-column type heat dissipation structure (108), the heat energy inside the heat dissipation member (100) can also be directly dissipated to the exterior through a larger heat dissipation area defined by the multiple-column type heat dissipation structure (108) at the inner recessed surface of the cup-shaped structure and the annular surface of heat dissipation member (101) of the heat dissipation member (100), thereby assisting the electric-powered light emitting unit (200) to dissipate heat to the exterior.

12. A Cup-shaped heat dissipation member applicable in electric-powered light emitting unit as claimed in claim 1, wherein the top of the heat dissipation member (100) opposite to the installation location of the electric-powered light emitting unit (200) is additionally installed with a protection net (109).

13. A Cup-shaped heat dissipation member applicable in electric-powered light emitting unit as claimed in claim 2, wherein the top of the heat dissipation member (100) opposite to the installation location of the electric-powered light emitting unit (200) is additionally installed with a protection net (109).

14. A Cup-shaped heat dissipation member applicable in electric-powered light emitting unit as claimed in claim 1, wherein the top of the heat dissipation member (100) opposite to the installation location of the electric-powered light emitting unit (200) is installed with a top cover (110), and a ventilation port (112) and a support column (111) served for combining and supporting are formed between the top cover (110) and the heat dissipation member (100).

15. A Cup-shaped heat dissipation member applicable in electric-powered light emitting unit as claimed in claim 2, wherein the top of the heat dissipation member (100) opposite to the installation location of the electric-powered light emitting unit (200) is installed with a top cover (110), and a ventilation port (112) and a support column (111) served for combining and supporting are formed between the top cover (110) and the heat dissipation member (100).

16. A Cup-shaped heat dissipation member applicable in electric-powered light emitting unit as claimed in claim 1, wherein the support column (111) served for combining and supporting is installed between the top of the heat dissipation member (100) opposite to the installation location of the electric-powered light emitting unit (200) and the top cover (110), and the periphery of the ventilation port (112) is additionally installed with the protection net (109).

17. A Cup-shaped heat dissipation member applicable in electric-powered light emitting unit as claimed in claim 2, wherein the support column (111) served for combining and supporting is installed between the top of the heat dissipation member (100) opposite to the installation location of the electric-powered light emitting unit (200) and the top cover (110), and the periphery of the ventilation port (112) is additionally installed with the protection net (109).
